(19) United States
(12) Patent Application Publication
(10) Pub. No.: US 2020/0210309 A1
(43) Pub. Date: Jul. 2, 2020

(54) CONTROLLER AND OPERATION METHOD THEREOF

(71) Applicant: SK hynix Inc., Gyeonggi-do (KR)

(72) Inventor: Won-Jin JUNG, Gyeonggi-do (KR)

(21) Appl. No.: 16/664,283

(22) Filed: Oct. 25, 2019

(30) Foreign Application Priority Data
Jan. 2, 2019 (KR) 10-2019-0000317

(51) Int. Cl. G06F 11/34; G06F 3/06; G06F 11/30

(52) U.S. Cl. CPC G06F 11/3442; G06F 3/0679; G06F 3/0616; G06F 3/0619; G06F 11/3037; G06F 11/3476; G06F 11/3034

(57) ABSTRACT

Provided is a controller for controlling a memory device including a plurality of memory blocks. The controller may include a monitoring component suitable for monitoring a memory block usage of the plurality of memory blocks, and storing an actual memory block usage for a predetermined cycle, a memory block usage comparator suitable for calculating a desired memory block usage indicating a maximum memory block usage for the predetermined cycle, and comparing the desired memory block usage to the actual memory block usage, and a background operation manager suitable for performing a background operation according to the memory block usage comparison result.

### CROSS-REFERENCE TO RELATED APPLICATION

This application claims priority under 35 U.S.C. § 119 to Korean Patent Application No. 10-2019-0000317 filed on Jan. 2, 2019, which is incorporated herein by reference in its entirety.

### BACKGROUND

### 1. Field

Various embodiments of the present disclosure relate to a controller for controlling a memory device and an operation method thereof.

### 2. Discussion of the Related Art

The computer environment paradigm has been transitioning to ubiquitous computing, which enables computing systems to be used anytime and anywhere. As a result, use of portable electronic devices such as mobile phones, digital cameras, and laptop computers has rapidly increased. These portable electronic devices generally use a memory system having one or more memory devices for storing data. A memory system may be used as a main data storage system or an auxiliary data storage system of a portable electronic device.

Since they have no moving parts, memory systems provide advantages such as excellent stability and durability, high information access speed, and low power consumption. Examples of memory systems having such advantages include universal serial bus (USB) memory devices, memory cards having various interfaces, and solid-state drives (SSD).

### SUMMARY

Various embodiments of the present invention are directed to an improved controller for a memory system, a memory system including the controller and a method of operation thereof.

The controller may optimize the performance of a memory device employed by the memory system.

The controller may improve the reliability of the memory device while guaranteeing the warranty period of the memory device. According to an embodiment of the present invention, there is provided a controller for controlling a memory device. The memory device may include a plurality of memory blocks. The controller may include: a monitoring component suitable for monitoring a memory block usage of the plurality of memory blocks, and storing an actual memory block usage for a predetermined cycle; a memory block usage comparator suitable for calculating a desired memory block usage indicating a maximum memory block usage for the predetermined cycle, and comparing the desired memory block usage to the actual memory block usage; and a background operation manager suitable for performing a background operation according to the memory block usage comparison result.

According to an embodiment of the present invention, there is provided an operation method of a controller which controls a memory device including a plurality of memory blocks. The operation method may include: monitoring an actual memory block usage of the plurality of memory blocks for a predetermined cycle; comparing the actual memory block usage to a desired memory block usage indicating the maximum memory block usage for the predetermined cycle; and performing a background operation according to the memory block usage comparison result.

According to an embodiment of the present invention, there is provided a controller for controlling the operation of a memory device. The controller may be suitable for: calculating a desired memory block usage indicating a maximum memory block usage for a predetermined cycle; comparing the desired memory block usage to an actual memory block usage; and performing a background operation according to the memory block usage comparison result.

These and other advantages and features of the present invention will become apparent to a person of ordinary skill in the art to which the present invention belongs from the following detailed description in conjunction with the following drawings.

### BRIEF DESCRIPTION OF THE DRAWINGS

FIG. 1 schematically illustrates an example of a data processing system including a memory systemin accordance with an embodiment of the present invention.

FIG. 2 is a schematic diagram illustrating a configuration of a memory device employed in the memory system of FIG. 1 in accordance with an embodiment.

FIG. 3 is a circuit diagram illustrating a configuration of a memory cell array of a memory block of the memory device shown in FIG. 1 in accordance with an embodiment.

FIG. 4 is a block diagram illustrating a three-dimensional structure of the memory device shown in FIG. 2 in accordance with an embodiment.

FIG. 5 is a graph describing a remaining memory block usage in accordance with an embodiment of the present invention.

FIG. 6 schematically illustrates a memory system including a controller and a memory device in accordance with an embodiment of the present invention.

FIG. 7 is a flowchart of an operation of the memory system of FIG. 6 in accordance with an embodiment of the present invention.

FIG. 8 is a diagram describing an example of an additional background operation in accordance with an embodiment of the present invention.

FIGS. 9 to 17 are diagrams schematically illustrating application examples of the data processing system, in accordance with various embodiments of the present invention.

### DETAILED DESCRIPTION

Hereafter, various embodiments of the present invention will be described in detail with reference to the accompanying drawings. It should be understood that the following descriptions will be focused on those features required for understanding an operation in accordance with an embodiment of the present invention, and descriptions of other well-known features which are not needed for understanding the invention may be omitted in order not to unnecessarily obscure the disclosure of the subject matter of the present invention.

Various embodiments of the present invention will be described in greater detail with reference to the accompanying drawings. The drawings are schematic illustrations of various embodiments (and intermediate structures). As such, variations from the configurations and shapes of the illustrations as a result, for example, of manufacturing techniques and/or tolerances, are to be expected. Thus, the described embodiments should not be construed as being limited to the particular configurations and shapes illustrated herein but may include deviations in configurations and shapes which do not depart from the spirit and scope of the present invention as defined in the appended claims.

The present invention is described herein with reference to cross-section and/or plane illustrations of idealized embodiments of the present invention. However, embodiments of the present invention should not be construed as limiting the inventive concept. Although a few embodiments of the present invention will be shown and described, it will be appreciated by those of ordinary skill in the art that changes may be made in these embodiments without departing from the principles and spirit of the present invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

It will be further understood that when an element is referred to as being “connected to”, or “coupled to” another element, it may be directly on, connected to, or coupled to the other element, or one or more intervening elements may be present. Furthermore, the connection/coupling may not be limited to a physical connection but may also include a non-physical connection, e.g., a wireless connection.

In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention.

As used herein, singular forms are intended to include the plural forms as well, unless the context clearly indicates otherwise. The articles ‘a’ and ‘an’ as used in this application and the appended claims should generally be construed to mean ‘one or more’ unless specified otherwise or clear from context to be directed to a singular form.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure.

It will be further understood that terms, such as those defined in commonly used dictionaries, should be interpreted as having a meaning that is consistent with their meaning in the context of the present disclosure and the relevant art, and will not be interpreted in an idealized or overly formal sense unless expressly so defined herein.

It should be understood that the drawings are simplified schematic illustrations of the described devices and may not include well known details to avoid obscuring the features of the invention.

It should also be noted that features present in one embodiment may be used with one or more features of another embodiment without departing from the scope of the invention.

It is further noted, that in the various drawings, like reference numbers designate like elements.

Hereafter, embodiments will be described in more detail with reference to the accompanying drawings.

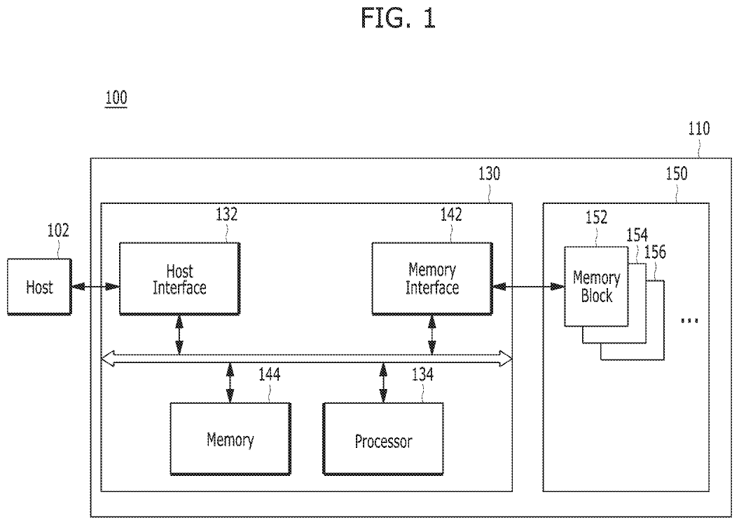

FIG. 1 is a block diagram illustrating a data processing system 100 in accordance with an embodiment of the present invention.

Referring to FIG. 1, the data processing system 100 may include a host 102 operatively coupled to a memory system 110.

The host 102 may include any of various portable electronic devices such as a mobile phone, an MP3 player and a laptop computer, or any of various non-portable electronic devices such as a desktop computer, a game machine, a television (TV), and a projector.

The host 102 may include at least one operating system (OS), which may manage and control the overall functions and operations of the host 102, and provide operation between the host 102 and a user using the data processing system 100 or the memory system 110. The OS may support functions and operations corresponding to the use, purpose, and usage of a user. For example, the OS may be divided into a general OS and a mobile OS, depending on the mobility of the host 102. The general OS may be divided into a personal OS and an enterprise OS, depending on the environment of a user.

For example, the personal OS configured to support a function of providing a service to general users may include Windows and Chrome, and the enterprise OS configured to secure and support high performance may include Windows server, Linux and Unix. Furthermore, the mobile OS configured to support a function of providing a mobile service to users and a power saving function of a system may include Android, iOS and Windows Mobile. The host 102 may include a plurality of OSs, and execute an OS to perform an operation corresponding to a user's request on the memory system 110.

The memory system 110 may operate to store data for the host 102 in response to a request of the host 102. Non-limiting examples of the memory system 110 may include a solid state drive (SSD), a multi-media card (MMC), a secure digital (SD) card, a universal storage bus (USB) device, a universal flash storage (UFS) device, compact flash (CF) card, a smart media card (SMC), a personal computer memory card international association (PCMCIA) card and memory stick. The MMC may include an embedded MMC (eMMC), a reduced size MMC (RS-MMC) and a micro-MMC, The SD card may include a mini-SD card and a micro-SD card.

The memory system 110 may be embodied by various types of storage devices. Examples of such storage devices may include, but are not limited to, volatile memory devices such as a dynamic random access memory (DRAM) and a static RAM (SRAM), and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM or ReRAM) and a flash memory.

The memory system 110 may include the controller 130 and the memory device 150. The memory device 150 may store data for the host 102, and the controller 130 may control data storage into the memory device 150.

The controller 130 and the memory device 150 may be integrated into a single semiconductor device. For example, the controller 130 and the memory device 150 may be integrated as one semiconductor device to constitute a solid-state drive (SSD). When the memory system 110 is used as an SSD, the operating speed of the host 102 connected to the memory system 110 can be improved.

In addition, the controller 130 and the memory device 150 may be integrated as one semiconductor device to constitute a memory card. For example, the controller 130 and the memory device 150 may constitute a memory card such as a personal computer memory card international association (PCMCIA) card, a compact flash (CF) card, a smart media (SM) card, a memory stick, a multimedia card (MMC) including a reduced size MMC (RS-MMC) and a micro-MMC, a secure digital (SD) card including mini-SD card, a micro-SD card and an SDHC card, or a universal flash storage (UFS) device.

Non-limiting application examples of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device and may retain data stored therein even though power is not supplied. The memory device 1.50 may store data provided from the host 102 through a write operation, and provide data stored therein to the host 102 through a read operation. The memory device 150 may include a plurality of memory blocks 152, 154, 156 . . . each of which may include a plurality of pages, and each of the pages may include a plurality of memory cells coupled to a word line. According to an embodiment of the present invention, the memory device 150 may be a flash memory. The flash memory may have a 3-dimensional (3D) stack structure.

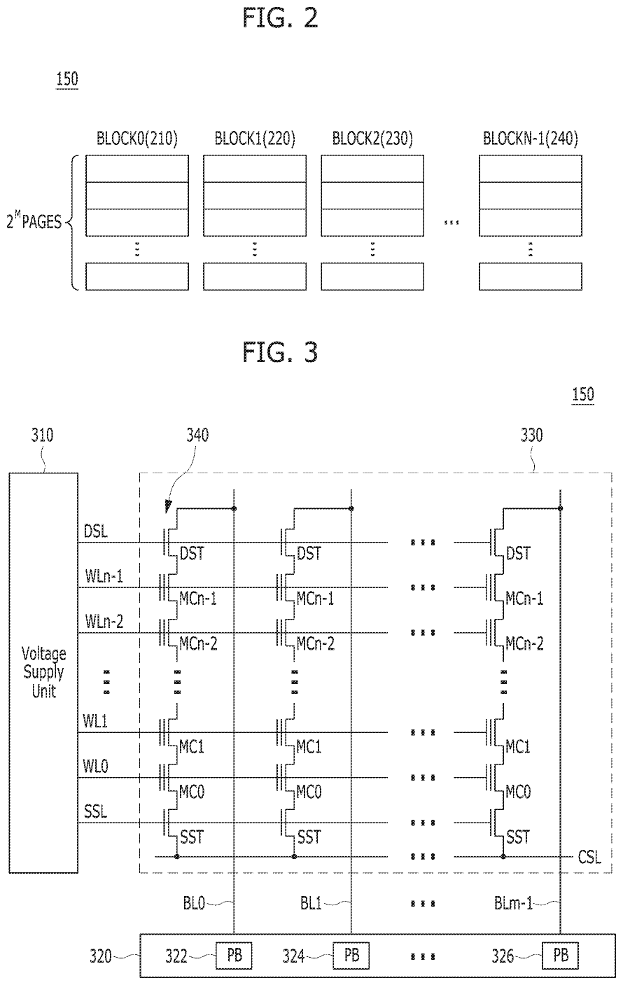

A structural example of the memory device 150 including its 3D stack structure will be described in detail later with reference to FIGS. 2 to 4.

The controller 130 may control the memory device 150 in response to a request from the host 102. For example, the controller 130 may provide data read from the memory device 150 to the host 102, and store data provided from the host 102 into the memory device 150. For this operation, the controller 130 may control the read, program and erase operations of the memory device 150.

The controller 130 may include a host interface (I/F) 132, a processor 134, a memory I/F 142 such as a NAND flash controller (NFC), and a memory 144 all operatively coupled via an internal bus. The internal bus is generally indicated by a double-headed arrow.

The host I/F 132 may be configured to process a command and data of the host 102, and may communicate with the host 102 through one or more of various interface protocols such as a universal serial bus (USB), a multi-media card (MMC), a peripheral component interconnect-express (PCI-e or PCIe), a small computer system interface (SCSI), a serial-attached SCSI (SAS), a serial advanced technology attachment (SATA), a parallel advanced technology attachment (PATA), an enhanced small disk interface (ESDI) and an integrated drive electronics (IDE). The host I/F 132 may be driven through firmware referred to as a host interface layer (HIL) in order to exchange data with the host.

The memory I/F 142 may serve as a memory/storage interface for interfacing the controller 130 and the memory device 150 such that the controller 130 controls the memory device 150 in response to a request from the host 102. The memory I/F 142 may work as an interface (e.g., a NAND flash interface) for processing a command and data between the controller 130 and the memory device 150. For example, the memory device 150 may be a flash memory or, more specifically, a NAND flash memory, and the memory I/F 142 may generate a control signal for the memory device 150 and process data to be provided to the memory device 150 under the control of the processor 134. Specifically, the memory I/F 142 may support data transfer between the controller 130 and the memory device 150. The memory I/F 142 may be driven through firmware referred to as a flash interface layer (FIL) in order to exchange data with the memory device 150.

In accordance with an implementation, the memory I/F 142 may include an error correction circuit (ECC) component. The ECC component may detect and correct an error contained in the data read from the memory device 150. In other words, the ECC component may perform an error correction decoding process to the data read from the memory device 150 through an ECC value used during an ECC encoding process. According to a result of the error correction decoding process, the ECC component may output a signal, for example, an error correction success/fail signal. When the number of error bits is more than a threshold value of correctable error bits, the ECC component may not correct the error bits, and may output an error correction fail signal.

The ECC component may perform error correction through a coded modulation such as a Low-Density Parity Check (LDDC) code, a is Bose-Chaudhri-Hocquenghem (BCH) code, a turbo code, a Reed-Solomon code, convolution code, a Recursive Systematic Code (RSC), a Trellis-Coded Modulation (TCM) and a Block coded modulation (BCM). The ECC component is not limited to any specific structure. The ECC component may include all circuits, modules, systems or devices for error correction.

The memory 144 (also referred to as the controller memory) may serve as a working memory of the memory system 110 and the controller 130, and store data for driving the memory system 110 and the controller 130. The controller 130 may control the memory device 150 to perform read, program and erase operations in response to a request from the host 102. The controller 130 may provide data read from the memory device 150 to the host 102, and may store data provided from the host 102 into the memory device 150. The memory 144 may store data required for the controller 130 and the memory device 150 to perform these operations.

The memory 144 may be embodied by a volatile memory. For example, the memory 144 may be embodied by a static random-access memory (SRAM) or a dynamic random-access memory (DRAM). The memory 144 may be disposed within or out of the controller 130. FIG. 1 exemplifies the memory 144 disposed within the controller 130. According to a variation of the described embodiment, the memory 144 may be implemented as a volatile memory external to the controller 130. The external memory 144 may have an interface for transferring data between the external memory 144 and the controller 130.

The memory 144 may store data for performing a data operation such as, for example, a write or a read operation between the host and the memory device 150. The memory 144 may store data when the data write or read operation is performed. In an embodiment, the memory 144 may include a program memory, a data memory, a write buffer/cache, a read buffer/cache, a data buffer/cache, and a map buffer/cache.

The processor 134 may control he overall operations of the memory system 110. The processor 134 may drive firmware to control the overall operations of the memory system 110. The firmware may be referred to as flash translation layer (FTL). The processor 134 may be realized as a microprocessor or a central processing unit (CPU).

For example, the controller 130 may perform an operation requested by the host 102 through the processor 134. In other words, the controller 130 may perform a command operation corresponding to a command received from the host 102. The controller 130 may perform a foreground operation as the command operation corresponding to the command received from the host 102. For example, the controller 130 may perform a program operation corresponding to a write command, a read operation corresponding to a read command, an erase operation corresponding to an erase command, and a parameter set operation corresponding to a set parameter command or a set feature command.

Also, the controller 130 may perform a background operation onto the memory device 150 through the processor 134. The background operation performed onto the memory device 150 may include an operation of copying and processing data stored in some memory blocks among the memory blocks 152 to 156 of the memory device 150 into other memory blocks, e.g., a garbage collection (GC) operation, an operation of swapping between the memory blocks 152 to 156 or between the data of the memory blocks 152 to 156, e.g., a wear-leveling (WL) operation, an operation of storing the map data stored in the controller 130 in the memory blocks 152 to 156, e.g., a map flush operation, or an operation of managing bad blocks of the memory device 150, e.g., a bad block management operation of detecting and processing bad blocks among the memory blocks 152 to 156.

A memory device of the memory system in accordance with an embodiment of the present invention is described in detail with reference to FIGS. 2 to 4.

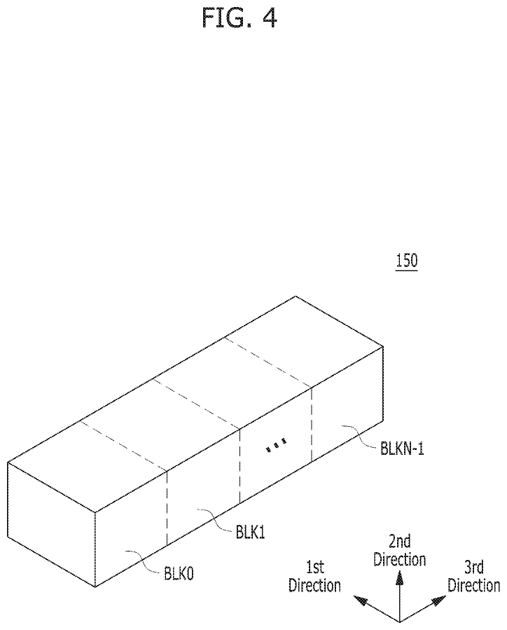

FIG. 2 is a schematic diagram illustrating a configuration of the memory device 150, FIG. 3 is a circuit diagram illustrating a configuration of a memory cell array of a memory block in the memory device 150, and FIG. 4 is a schematic diagram illustrating a 3D structure of the memory device 150.

Referring to FIG. 2, the memory device 150 may include a plurality of memory blocks BLOCKO to BLOCKN-1, BLOCK0 (210), BLOCK1 (220), BLOCK2 (230), and to BLOCKN-1 (240). Each of the memory blocks 210, 220, 230 and 240 may include a plurality of pages, for example 2m pages, the number of which may vary according to circuit design. For example, in some applications, each of the memory blocks may include M pages. Each of the pages may include a plurality of memory cells that are coupled to a word line WL.

The memory device 150 may include a plurality of memory blocks, which may include a single level cell (SLC) memory block storing 1-bit data and/or a mufti-level cell (MLC) memory block storing multi-bit data. The SLC memory blocks may include a plurality of pages that are realized by memory cells storing one-bit data in one memory cell. The SLC memory blocks may have a quick data operation performance and high durability. On the other hand, the MLC memory blocks may include a plurality of pages that are realized by memory cells storing multi-bit data, e.g., data of two or more bits, in one memory cell. The MLC memory blocks may have a greater data storing space than the SLC memory blocks. In other words, the MLC memory blocks may be highly integrated.

In accordance with an embodiment of the present invention, the memory device 150 is described as a non-volatile memory, such as a flash memory, e.g., a NAND flash memory. However, the memory device 150 may be realized as any of a Phase Change Random Access Memory (PCRAM), a Resistive Random-Access Memory (RRAM or ReRAM), a Ferroelectric Random-Access Memory (FRAM), a Spin Transfer Torque Magnetic Random Access Memory (S I I -RAM or S -MRAM).

The memory blocks 210, 220, 230, . . . 240 may store the data transferred from the host 102 through a program operation, and transfer data stored therein to the host 102 through a read operation. The memory blocks 210, 220, 230, . . . 240 may correspond to the memory blocks 152 to 156 included in the memory device 150 of the memory system 110 of FIG. 1.

Referring to FIG. 3, a memory block 330, which may correspond to any of the plurality of memory blocks 152 to 156 included in the memory device 150 of the memory system 110, may include a plurality of cell strings 340 coupled to a plurality of corresponding bit lines BL0 to BLm-1. The cell string 340 of each column may include one or more drain select transistors DST and one or more source select transistors SST. Between the drain and source select transistors DST and SST, a plurality of memory cells or memory cell transistors MC0 to MCn-1 may be coupled in series. According to an embodiment of the present invention, each of the memory cells MC0 to MCn-1 may be embodied by an MLC capable of storing data information of a plurality of bits. Each of the cell strings 340 may be electrically coupled to a corresponding bit line among the plurality of bit lines BL0 to BLm-1. For example, as illustrated in FIG. 3, the first cell string is coupled to the first bit line BLO, and the last cell string is coupled to the last bit line BLm-1. For reference, in FIG. 3, ‘DSL’ denotes a drain select line, ‘SSL’ denotes a source select line, and ‘CSL’ denotes a common source line.

Although FIG. 3 illustrates NAND flash memory cells, the invention is not limited in this way. It is noted that the memory cells may be NOR flash memory cells, or hybrid flash memory cells including two or more types of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply 310 which provides word line voltages including a program voltage, a read voltage and a pass voltage to supply to the word lines according to an operation mode. The voltage generation operation of the voltage supply 310 may be controlled by a control circuit (not illustrated). Under the control of the control circuit, the voltage supply 310 may select one of the memory blocks (or sectors) of the memory cell array, select one of the word lines of the selected memory block, and provide the word line voltages to the selected word line and the unselected word lines as may be needed.

The memory device 150 may include a read and write (read/write) circuit 320 which is controlled by the control circuit. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

The memory device 150 may be embodied by a two-dimensional (2D) or three-dimensional (3D) memory device. Particularly, as illustrated in FIG. 4, the memory device 150 may be embodied by a nonvolatile memory device having a 3D stack structure. When the memory device 150 has a 3D structure, the memory device 150 may include a plurality of memory blocks BLOCK0 to BL0CKN-1.

Each memory block 330 included in the memory device 150 may include a plurality of NAND strings NS that are extended in the second direction, and a plurality of NAND strings NS (not shown) that are extended in the first direction and the third direction. Each of the NAND strings NS may be coupled to a bit line BL, at least one drain selection line DSL, at least one source selection line SSL, a plurality of word lines WL, at least one dummy word line DWL (not shown), and a common source line CSL, and each of the NAND strings NS may include a plurality of transistor structures.

In short, each memory block 330 of the memory device 150 may be coupled to a plurality of bit lines BL, a plurality of drain selection lines DSL, a plurality of source selection lines SSL, a plurality of word lines WL, a plurality of dummy word lines DWL, and a plurality of common source lines CSL, and each memory block 330 may include a plurality of NAND strings NS. Also, in each memory block 330, one-bit line BL may be coupled to a plurality of NAND strings NS to realize a plurality of transistors in one NAND string NS. Also, a drain selection transistor DST of each NAND string NS may be coupled to a corresponding bit line BL, and a source selection transistor SST of each NAND string NS may be coupled to a common source line CSL. Memory cells MC may be provided between the drain selection transistor DST and the source selection transistor SST of each NAND string NS. In other words, a plurality of memory cells may be realized in each memory block 330 of the memory device 150.

As the memory device 150 repeats a program operation and an erase operation, the lifetime of the memory device 150 may come to an end. For example, the maximum program-erase cycle (hereafter, referred to as P/E cycle) count of an SLC memory block may be approximately 100,000 times. That is, a maximum of is 100,000 program-erase operations may be performed on the SLC memory block. Similarly, the maximum PIE cycle count of an MLC memory block may be approximately 10,000 times, and the maximum PIE cycle count of a TLC memory block may be approximately 1,000 times.

The number of memory blocks in the memory device 150 and the maximum P/E cycle count may decide the maximum memory block usage of the memory device 150. Specifically, the maximum memory block usage may be derived by multiplying the number of memory blocks in the memory device 150 by the maximum P/E cycle count. For example, when the number of memory blocks in a memory device including TLC memory blocks is 1,000, the lifetime of the corresponding memory device may come to an end after data corresponding to a maximum of approximately 1 million memory blocks are written, because each of the TLC memory blocks can be programmed a maximum of 1,000 times.

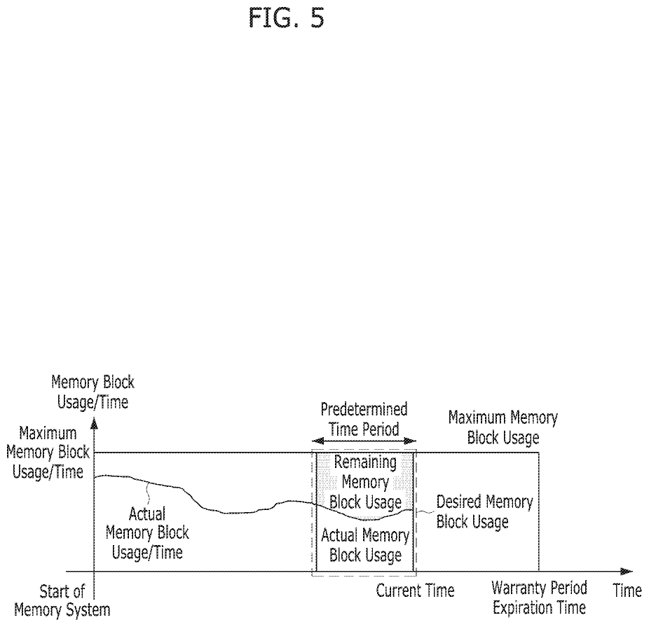

FIG. 5 is a graph describing a remaining memory block usage in accordance with an embodiment of the present invention. The horizontal axis of the graph indicates time, and the vertical axis indicates a memory block usage per unit of time.

The requirements of the memory system 110 may define a certain warranty period. The horizontal axis of the graph displays the time at which the warranty period ends after the start of using the memory system 110.

The maximum memory block usage and the warranty period may decide the maximum memory block usage per unit of time. When the memory system 110 is used at less than the maximum memory block usage per unit of time over the entire period in which the memory system 110 is used, the warranty period may be guaranteed.

In this specification, the maximum number of memory blocks which can be used for a predetermined time period while satisfying the warranty period may be defined as a desired memory block usage. The desired memory block usage may be derived by multiplying the maximum memory block usage per unit of time by the predetermined time period. In the graph, a dotted line may indicate the desired memory block usage. For example, when the maximum memory block usage of the memory device including TLC memory blocks is approximately 1 million blocks and the warranty period of the memory device is three years, a desired memory block usage of one day is approximately 1,000 blocks.

General users may not store a large amount of data corresponding to the desired memory block usage in the memory system 110 for the predetermined time period. In this specification, a difference between the desired memory block usage and an actual memory block usage for a predetermined time period may be defined as a remaining memory block usage. In the graph, a shaded portion illustrated in the dotted line may indicate the remaining memory block usage.

In accordance with an embodiment, the controller 130 may perform an additional background operation by using memory blocks corresponding to the remaining memory block usage, in order to improve the performance or reliability of the memory system 110, For example, the controller 130 may rearrange data stored in the memory device 150 by performing additional garbage collection, thereby improving the performance of the memory system 110.

Therefore, the controller 130 may perform the additional background operation by consuming the remaining memory block usage, thereby improving the performance or reliability of the memory system 110 while guaranteeing the warranty period of the memory system 110.

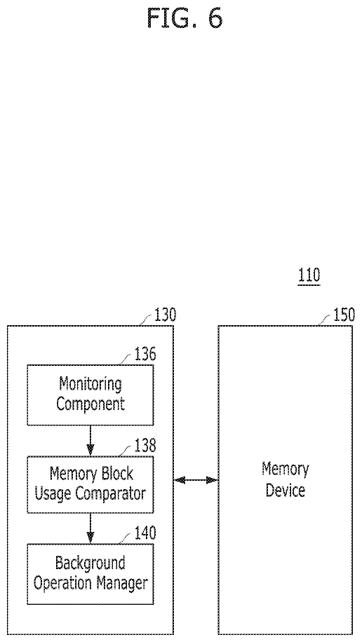

FIG. 6 schematically illustrates the memory system 110 including the controller 130 and the memory device 150 in accordance with the present embodiment.

The memory system 110 may include the memory device 150 including a plurality of memory blocks and the controller 130 for controlling the memory device 150. The memory device 150 and the controller 130 may correspond to the memory device 150 and the controller 130 which have been described with reference to FIG. 1.

The controller 130 in accordance with the present embodiment may include a monitoring component 136, a memory block usage comparator 138 and a background operation manager 140. The is monitoring component 136 may monitor an actual memory block usage of the memory device 150.

According to an embodiment of the present invention, the monitoring component 136 may determine the actual memory block usage of the memory device 150 in a predetermined cycle. The monitoring component 136 may provide the actual memory block usage in the predetermined cycle to the memory block usage comparator 138.

The memory block usage comparator 138 may calculate a predetermined cycle of desired memory block usage, and compare the desired memory block usage to the predetermined cycle of actual memory block usage.

The memory block usage comparator 138 may calculate the predetermined cycle of desired memory block usage by multiplying the maximum memory block usage per unit of time by the predetermined cycle.

When the actual memory block usage is less than the desired memory block usage, the memory block usage comparator 138 may provide a trigger signal to the background operation manager 140 to perform an additional background operation.

According to an embodiment of the present invention, when the actual memory block usage is less than the desired memory block usage, the memory block usage comparator 138 may derive a remaining memory block usage based on the actual memory block usage and the desired memory block usage. The memory block usage comparator 138 may provide the trigger signal and the remaining memory block usage to the background operation manager 140.

The background operation manager 140 may perform an additional background operation depending on the memory block usage comparison result. For example, even when a garbage collection operation does not need to be performed at the moment because a sufficient number of free blocks are included in the memory device 150, the background operation manager 140 may perform the garbage collection operation in order to improve the performance of the memory system 110.

According to an embodiment of the present invention, the background operation manager 140 may end the background operation when the remaining memory block usage is completely consumed.

In accordance with an implementation, the monitoring component 136, the memory block usage comparator 138 and the background operation manager 140 may be loaded to the memory 144 described with reference to FIG. 1, and driven by the processor 134. In accordance with an implementation, the monitoring component 136, the memory block usage comparator 138 and the background operation manager 140 may be implemented as a field programmable gate array (FPGA).

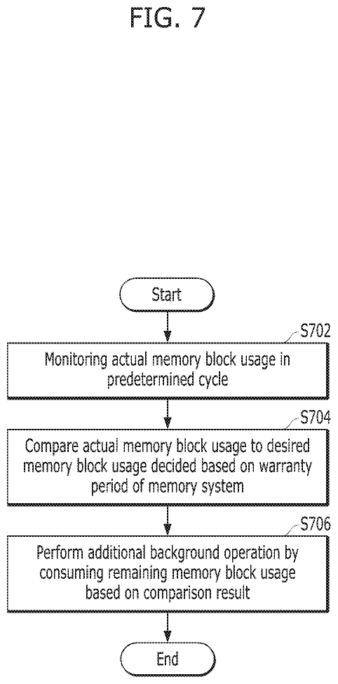

FIG. 7 is a flowchart of an operation of the memory system 110 in accordance with an embodiment of the present invention.

At step S702, the monitoring component 136 may monitor an actual memory block usage in a predetermined cycle.

The monitoring component 136 may monitor the actual memory block usage by monitoring the amount of data which are actually written to the memory device 150. The amount of data which are actually written may include both the data written in response to a write command from the host 102 and the data written by a background operation.

For example, he monitoring component 1.36 may monitor the actual memory block usage by monitoring a P/E cycle change.

As another example, the monitoring component 136 may monitor the actual memory block usage by monitoring the amount of host data received from the host 102. Since the amount of host data does not include the amount of data written by the background operation, the amount of host data may not be equal to the actual memory block usage. However, the monitoring component 136 may estimate the actual memory block usage of the memory device 150 based on the amount of host data. For example, the monitoring component 136 may estimate the actual memory block usage based on the amount of host data being proportional to the amount of data written by the background operation.

The monitoring component 136 may provide the monitored actual memory block usage to the memory block usage comparator 138 in a predetermined cycle.

At step S704, the memory block usage comparator 138 may compare the desired memory block usage to the predetermined cycle of actual memory block usage.

According to an embodiment of the present invention, the memory block usage comparator 138 may derive a remaining memory block usage based on the desired memory block usage and the predetermined cycle of actual memory block usage.

When the predetermined cycle of actual memory block usage is less than the desired memory block usage, the memory block usage comparator 138 may provide a trigger signal to the background operation manager 140 to perform an additional background operation. The memory block usage comparator 138 may provide the trigger signal and the remaining memory block usage to the background operation manager 140.

At step S706, the background operation manager 140 may perform the background operation based on the trigger signal and the remaining memory block usage.

For example, when the predetermined cycle of actual memory block usage is less than the desired memory block usage, the background operation manager 140 may perform the additional background operation by consuming the remaining memory block usage.

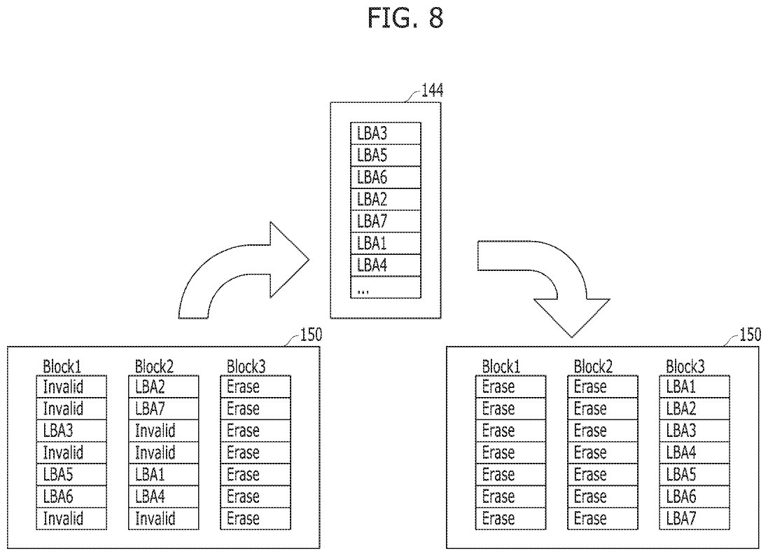

FIG. 8 is a diagram describing an example of an additional background operation which can be performed at step S706.

In accordance with an embodiment, the background operation manager 140 may perform an additional garbage collection operation as the additional background operation.

The background operation manager 140 may perform the additional garbage collection operation even when free blocks do not need to be further generated because a sufficient number of free blocks are included in the memory device 150.

In accordance with an embodiment, the processor 134 may perform the additional background operation by arranging data having sequential logical block addresses among valid data of victim blocks such that physical block addresses of the data are sequential, and copying the arranged data into a target block. The valid data may indicate data which the host 102 can access at the moment through a logical block address.

The left side of FIG. 8 illustrates the memory device 150 before the additional background operation is performed. First and second memory blocks Block1 and Block2 may indicate the victim blocks, and a third memory block Block3 may indicate the target block.

In the victim blocks, physical block addresses of data having sequential logical block addresses may be not sequential. Even when the host 102 is intended to access the data having sequential logical block addresses, it is necessary to search for mapping information between the logical block addresses and the physical block addresses whenever the physical block addresses of the data having sequential logical block addresses are not sequential. Therefore, the time required for accessing the data may be increased.

The background operation manager 140 may control the memory device 150 to read valid data among the data of the victim blocks. The valid data read from the memory device 150 may be buffered in the memory 144. The middle of FIG. 8 illustrates the memory 144 in which the valid data are buffered.

The background operation manager 140 may control the memory device 150 to sequentially write data having sequential logical block addresses among the buffered data to the target block. Therefore, the background operation manager 140 may store the valid data such that the physical block addresses of the data having sequential logical block addresses are sequential. The right side of FIG. 8 illustrates the memory device 150 in which the buffered data are written to the third memory block Block3 in order of logical block address, and the first and second memory blocks Block1 and Block2 are erased.

In accordance with an embodiment, when the background operation manager 140 performs the additional background operation, it is possible to reduce the time required to search for the mapping information for accessing the sequential data. Therefore, the read performance of the memory system 110 may be improved.

The additional background operation described with reference to FIG. 8 is only an example of the additional background operation which can be performed by the background operation manager 140, and the present embodiment is not limited thereto. Various examples of the additional background operation which can be performed by the background operation manager 140 will be described below.

In accordance with an embodiment, the background operation manager 140 may perform the additional background operation by classifying the valid data of the victim blocks into hot data which are frequently accessed and cold data which are infrequently accessed, and copying the hot data and the cold data into different target blocks. According to the related art, when hot data are frequently changed and invalidated in a memory block in which the hot data and cold data are mixed, the cold data may be frequently copied for a garbage collection operation. However, when the background operation manager 140 performs the additional background operation of copying the hot data and the cold data into different target blocks, it is possible to prevent a reduction in performance of the memory system 110, which may occur when the cold data are frequently copied.

In accordance with an embodiment, the background operation manager 140 may perform an additional read reclaim operation as the additional background operation.

For example, when the number of read operations performed in a memory block exceeds a threshold value, the background operation manager 140 may perform the additional background operation by copying data of the corresponding memory block and writing the copied data to a new memory block in response to a trigger signal of the memory block usage comparator 138. The background operation manager 140 may perform the additional background operation by consuming the remaining memory block usage, which makes it possible to prevent a read fail from occurring in the corresponding memory block even though read operations are repeatedly performed in the memory block. Therefore, in accordance with the present embodiment, the reliability of the memory system 110 can be improved.

In accordance with an embodiment, the background operation manager 140 may perform an additional operation history logging operation as the additional background operation.

According to the related art, the background operation manager 140 may store an operation history for a recent predetermined time period in the memory device 150. When a failure event occurs in the memory system 110, the processor 134 may refer to the operation history in order to recover the system from the failure event. In accordance with an embodiment, the background operation manager 140 may log an operation history for a longer time period than an existing time period, and the processor 134 may refer to the operation history in order to recover from a failure event which has occurred in the memory system 110. Thus, the memory system 110 can more readily recover from a failure event.

In accordance with an embodiment, the background operation manager 140 may perform the additional background operation based on reductions in actual lifetime and desired lifetime of the memory device 150 for a predetermined time period, that is, an actual memory block usage and a desired memory block usage for a predetermined time period. Therefore, the background operation manager 140 can optimize the performance of the memory system 110 or improve the reliability of the memory system 110 while guaranteeing the warranty period of the memory system 110.

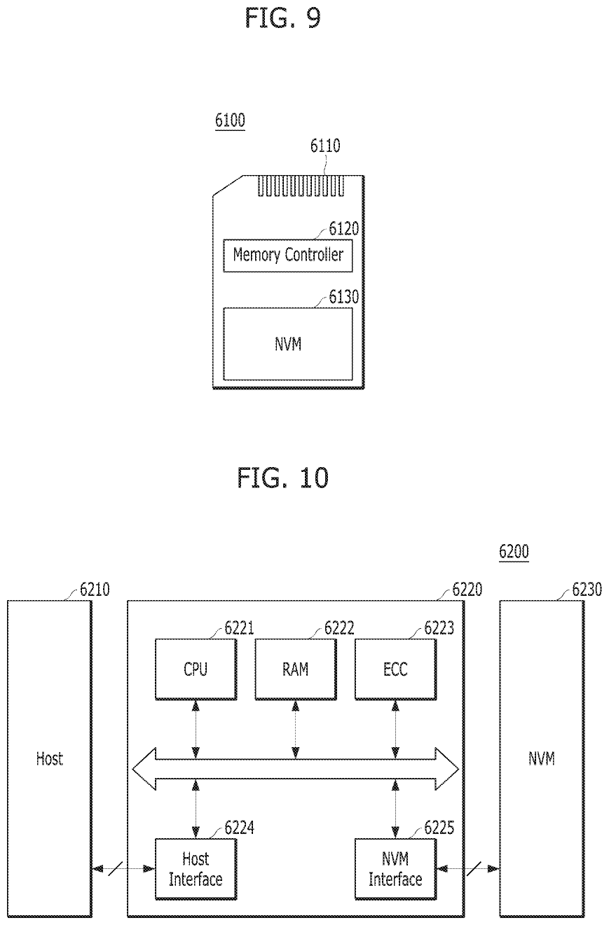

Hereafter, referring to FIGS. 9 to 17, a data processing system and electronic devices to which the memory system 110 described with reference to FIGS. 1 to 8 in accordance with the present embodiment and including the memory device 150 and the controller 130 is applied will be described in more detail.

FIG. 9 is a diagram schematically illustrating the data processing system including the memory system in accordance with an embodiment of the present invention. FIG. 9 schematically illustrates a memory card system 6100 to which the memory system in accordance with an embodiment is applied.

Referring to FIG. 9, the memory card system 6100 may include a memory controller 6120, a memory device 6130 and a connector 6110.

More specifically, the memory controller 6120 may be connected to the memory device 6130 embodied by a nonvolatile memory (NVM), and configured to access the memory device 6130. For example, the memory controller 6120 may be configured to control read, write, erase and background operations of the memory device 6130. The memory controller 6120 may be configured to provide an interface between the memory device 6130 and a host (not shown), and drive firmware for controlling the memory device 6130. That is, the memory controller 6120 may correspond to the controller 130 of the memory system 110 described with reference to FIG. 1, and the memory device 6130 may correspond to the memory device 150 of the memory system 110 described with reference to FIG. 1,

Thus, as shown in FIG. 1, the memory controller 6120 may include a random-access memory (RAM), a processor, a host interface, a memory interface and an error correction component.

The memory controller 6120 may communicate with an external device, for example the host 102 of FIG. 1, through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), is PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), wireless fidelity (Wi-Fi or WiFi) and Bluetooth. Thus, the memory system and the data processing system in accordance with an embodiment may be applied to wired and/or wireless electronic devices or particularly mobile electronic devices.

The memory device 6130 may be implemented by a nonvolatile memory. For example, the memory device 6130 may be implemented by any of various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM).

The memory controller 6120 and the memory device 6130 may be integrated into a single semiconductor device. For example, the memory controller 6120 and the memory device 6130 may be integrated to form a solid-state driver (SSD). Also, the memory controller 6120 and the memory device 6130 may form a memory card such as a PC card (e.g., Personal Computer Memory Card International Association (PCMCIA)), a compact flash (CF) card, a smart media card (e.g., SM and SMC), a memory stick, a multimedia card (e.g., MMC, RS-MMC, MMCmicro and eMMC), an secured digital (SD) card (e.g., miniSD card, microSD card and SDHC card) and a universal flash storage (UFS).

FIG. 10 is a diagram schematically illustrating another example of a data processing system 6200 including the memory system in accordance with an embodiment of the present invention.

Referring to FIG. 10, the data processing system 6200 may include a memory device 6230 having one or more nonvolatile memories (NVMs) and a memory controller 6220 for controlling the memory device 6230. The data processing system 6200 may serve as a storage medium such as a memory card (CF card, SD card or the like) or USB device, as described with reference to FIG. 1. The memory device 6230 may correspond to the memory device 150 in the memory system 110 illustrated in FIG. 1, and the memory controller 6220 may correspond to the controller 130 in the memory system 110 illustrated in FIG. 1.

The memory controller 6220 may control a read, write or erase operation on the memory device 6230 in response to a request of the host 6210, and the memory controller 6220 may include one or more central processing units (CPUs) 6221, a buffer memory such as a random access memory (RAM) 6222, an error correction code (ECC) circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the memory device 6230 to operate at high speed.

The ECC circuit 6223 may correspond to the ECC component 138 of the controller 130 illustrated in FIG. 1. As described with reference to FIG. 1, the ECC circuit 6223 may generate an error correction code (ECC) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. The ECC circuit 6223 may correct an error using the parity bit. For example, as described with reference to FIG. 1, the ECC circuit 6223 may correct an error using Low Density Parity Check (LDPC) code, Bose-Chaudhri-Hocquenghem (BCH) code, turbo code, Reed-Solomon code, convolution code, Recursive Systematic Code (RSC) or coded modulation such as Trellis-Coded Modulation (TCM) or Block coded modulation (BCM).

The memory controller 6220 may transmit and/or receive data to and/or from the host 6210 through the host interface 6224, and transmit/receive data to/from the memory device 6230 through the NVM interface 6225. The host interface 6224 may be connected to the host 6210 through a parallel advanced technology attachment (DATA) bus, serial advanced technology attachment (SATA) bus, small computer system interface (SCSI), universal serial bus (USB), peripheral component interconnect-express (PCIe) or NAND interface. The memory controller 6220 may have a wireless communication function with a mobile communication protocol such as wireless fidelity (WiFi) or Long-Term Evolution (LTE). The memory controller 6220 may be connected to an external device, for example, the host 6210 or another external device, and then transmit and/or receive data to and/or from the external device. In particular, as the memory controller 6220 is configured to communicate with the external device through one or more of various communication protocols, the memory system and the data processing system in accordance with an embodiment may be applied to wired and/or wireless electronic devices, particularly a mobile electronic device.

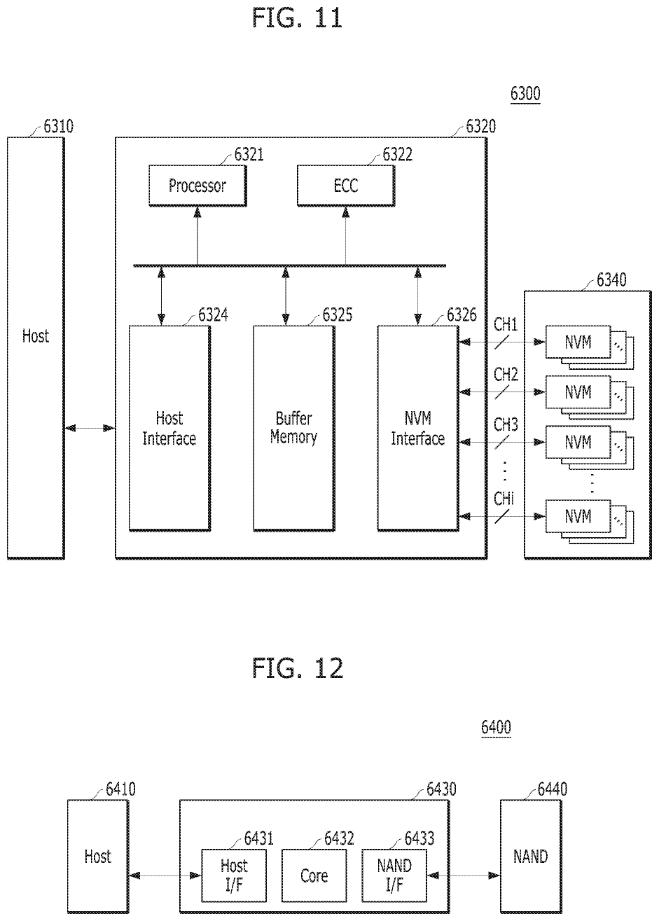

FIG. 11 is a diagram schematically illustrating another example of the data processing system including the memory system in accordance with an embodiment of the present invention. FIG. 11 schematically illustrates a solid-state drive (SSD) 6300 to which the memory system may be applied.

Referring to FIG. 11, the SSD 6300 may include a controller 6320 and a memory device 6340 including a plurality of nonvolatile memories (NVMs). The controller 6320 may correspond to the controller 130 in the memory system 110 of FIG. 1, and the memory device 6340 may correspond to the memory device 150 in the memory system of FIG. 1.

Specifically, the controller 6320 may be connected to the memory device 6340 through a plurality of channels CH1 to CHI. The controller 6320 may include one or more processors 6321, an error correction code (ECC) circuit 6322, a host interface 6324, a buffer memory 6325 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as dynamic random access memory (DRAM), synchronous DRAM (SDRAM), double data rate (DDR) SDRAM, low power DDR (LPDDR) SDRAM and graphics RAM (GRAM) or nonvolatile memories such as ferroelectric RAM (FRAM), resistive RAM (RRAM or ReRAM), spin-transfer torque magnetic RAM (STT-MRAM) and phase-change RAM (PRAM). For convenience of description, FIG. 10 illustrates that the buffer memory 6325 exists in the controller 6320. However, the buffer memory 6325 may exist outside the controller 6320.

The ECC circuit 6322 may calculate an error correction code (ECC) value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, a redundant array of independent disks (RAID) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 12 is a diagram schematically illustrating another example of the data processing system including the memory system in accordance with an embodiment of the present invention. FIG. 12 schematically illustrates an embedded Multi-Media Card (eMMC) 6400 to which the memory system may be applied.

Referring to FIG. 12, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

Specifically, the controller 6430 may be connected to the memory device 6440 through a plurality of channels. The controller 6430 may include one or more cores 6432, a host interface (I/F) 6431 and a memory interface, for example, a NAND interface (I/F) 6433.

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, Ultra High Speed (UHS)-I and UHS-II interface.

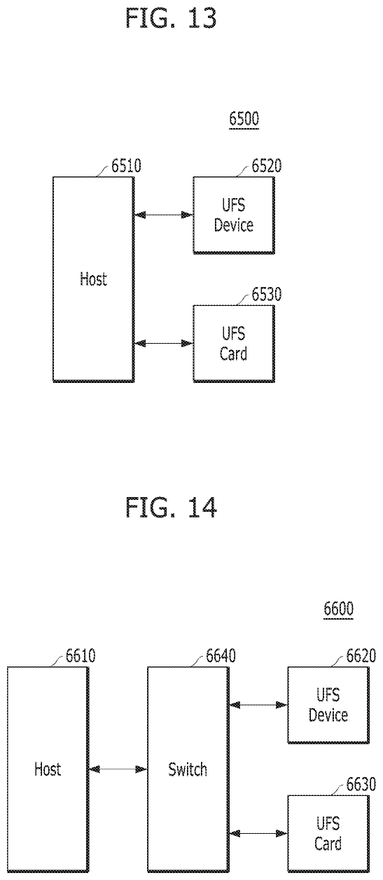

FIGS. 13 to 16 are diagrams schematically illustrating other examples of the data processing system including the memory system in accordance with one or more embodiments. FIGS. 13 to 16 schematically illustrate universal flash storage (UFS) systems to which the memory system may be applied.

Referring to FIGS. 13 to 16, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired and/or wireless electronic devices, particularly mobile electronic devices, the UFS devices 6520, 6620, 6720 and 6820 may serve as embedded UFS devices. The UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired and/or wireless electronic devices, particularly mobile electronic devices through UFS protocols. The UFS devices 6520, 6620, 6720 and 6820 and the UFS cards 6530, 6630, 6730 and 6830 may be embodied by the memory system 110 illustrated in FIG. 1. For example, in the UFS systems 6500, 6600, 6700 and 6800, the UFS devices 6520, 6620, 6720 and 6820 may be embodied in the form of the data processing system 6200, the SSD 6300 or the eMMC 6400 described with reference to FIGS. 10 to 12, and the UFS cards 6530, 6630, 6730 and 6830 may be embodied in the form of the memory card system 6100 described with reference to FIG. 9.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720 and 6820 and the UFS cards 6530, 6630, 6730 and 6830 may communicate with each other through various protocols other than the UFS protocol, for example, universal storage bus (USB) Flash Drives (UFDs), multi-media card (MMC), secure digital (SD), mini-SD, and micro-SD.

In the UFS system 6500 illustrated in FIG. 13, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. The UFS device 6520 and the UFS card 6530 may communicate with each other through link layer switching at the UniPro of the host 6510. According to an embodiment of the present invention, the configuration in which one UFS device 6520 and one UFS card 6530 are connected to the host 6510 has been exemplified for convenience of description. However, a plurality of UFS devices and UFS cards may be connected in parallel or in the form of a star to the host 6510, and a plurality of UFS cards may be connected in parallel or in the form of a star to the UFS device 6520, or connected in series or in the form of a chain to the UFS device 6520.

In the UFS system 6600 illustrated in FIG. 14, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 is may communicate with each other through link layer switching of the switching module 6640 at UniPro. According to an embodiment of the present invention, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640, and a plurality of UFS cards may be connected in series or in the form of a chain to the UFS device 6620.

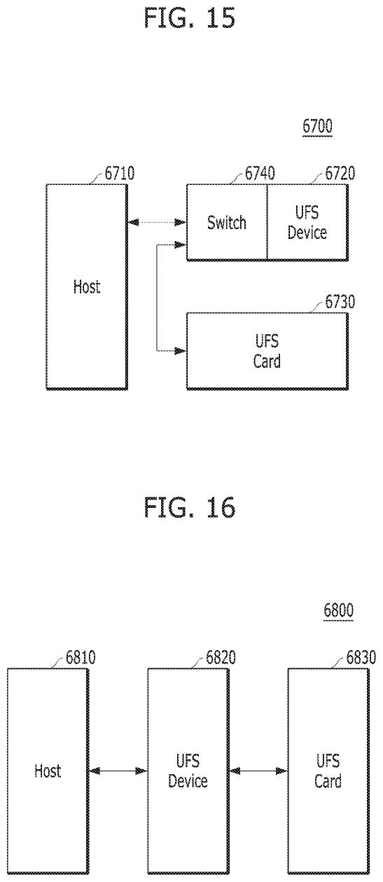

In the UFS system 6700 illustrated in FIG. 15, each of the host 6710, the UFS device 6720 and the UFS card 6730 may include UniPro. The host 6710 may communicate with the UFS device 6720 or the UFS card 6730 through a switching module 6740 performing a switching operation, for example, through the switching module 6740 which performs link layer switching at the UniPro, for example, L3 switching. The UFS device 6720 and the UFS card 6730 may communicate with each other through link layer switching of the switching module 6740 at the UniPro, and the switching module 6740 may be integrated as one module with the UFS device 6720 inside or outside the UFS device 6720. According to an embodiment of the present invention, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710, or connected in series or in the form of a chain to each other. Furthermore, a plurality of UFS cards may be connected in parallel or in the form of a star to the UFS device 6720.

In the UFS system 6800 illustrated in FIG. 16, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810, and the M-PHY and UniPro module for communication with the UFS card 6830, for example, through a target Identifier (ID) switching operation. The host 6810 and the UFS card 6830 may communicate with each other through target ID switching between the M-PHY and UniPro modules of the UFS device 6820. According to an embodiment of the present invention, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

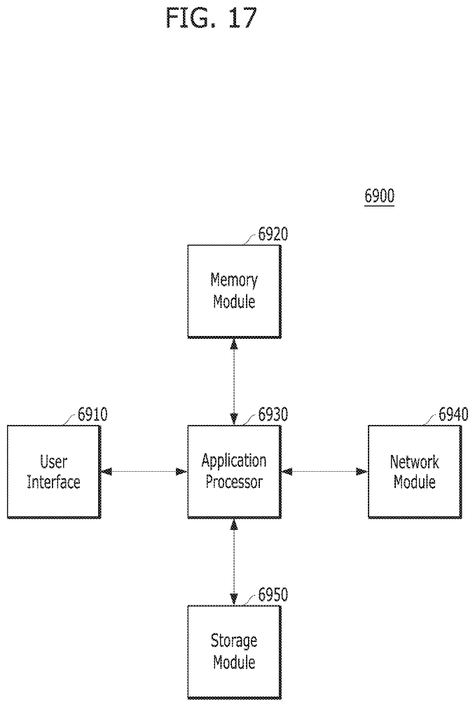

FIG. 17 is a diagram schematically illustrating another example of the data processing system including the memory system in accordance with an embodiment of the present invention. FIG. 17 is a diagram schematically illustrating a user system 6900 to which the memory system may be applied.

Referring to FIG. 17, the user system 6900 may include a user interface 6910, a memory module 6920, an application processor 6930, a network module 6940, and a storage module 6950.

Specifically, the application processor 6930 may drive components included in the user system 6900, for example, an operating system (OS), and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile random access memory (RAM) such as a dynamic RAM (DRAM), a synchronous DRAM (SDRAM), a double data rate (DDR) SDRAM, DDR2 SDRAM, DDR3 SDRAM, LPDDR SDARM, LPDDR2 SDRAM or LPDDR3 SDRAM or a nonvolatile RAM such as a phase-change RAM (PRAM), a resistive RAM (ReRAM), a magneto-resistive RAM (MRAM) or a ferroelectric RAM (FRAM). For example, the application processor 6930 and the memory module 6920 may be packaged and mounted, based on Package on Package (PoP).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (W max), wireless local area network (WLAN), ultra-wideband (UWB), Bluetooth, wireless display (WI-DI), thereby communicating with wired/wireless electronic devices, particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 11 to 16.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a monitor.

Furthermore, when the memory system 110 of FIG. 1 is applied to a mobile electronic device of the user system 6900, the application processor 6930 may control overall operations of the mobile electronic device, and the network module 6940 may serve as a communication module for controlling wired and/or wireless communication with an external device. The user interface 6910 may display data processed by the application processor 6930 on a display/touch module of the mobile electronic device, or support a function of receiving data from the touch panel.

In accordance with the present embodiments, it is possible to is provide a controller which can optimize the performance of a memory device or improve the reliability of the memory device while guaranteeing the warranty period of the memory device, and an operation method thereof.

Although various embodiments have been described for illustrative purposes, it will be apparent to those skilled in the art that various changes and modifications may be made without departing from the spirit and scope of the invention as defined in the following claims.

What is claimed is:

1. A controller for controlling a memory device including a plurality of memory blocks, the controller comprising:
a monitoring component suitable for monitoring a memory block usage of the plurality of memory blocks, and storing an actual memory block usage for a predetermined cycle;
a memory block usage comparator suitable for calculating a desired memory block usage indicating a maximum memory block usage for the predetermined cycle, and comparing the desired memory block usage to the actual memory block usage; and
a background operation manager suitable for performing a background operation according to the memory block usage comparison result.

2. The controller of claim 1, wherein the memory block usage comparator calculates the maximum memory block usage of the memory device based on the maximum program-erase (PIE) cycle count of the plurality of memory blocks and the capacity of the memory device, and calculates the desired memory block usage based on the maximum memory block usage, a warranty period, and the predetermined cycle.

3. The controller of claim 1, wherein the monitoring component calculates and stores the actual memory block usage for the predetermined cycle based on the amount of host data corresponding to a host write command provided to the controller from a host.

4. The controller of claim 1, wherein the monitoring component calculates and stores the actual memory block usage for the predetermined cycle based on PE cycle counts of the respective memory blocks.

5. The controller of claim 1, wherein the memory block usage comparator calculates a remaining memory block usage for the predetermined cycle based on the desired memory block usage and the actual memory block usage.

6. The controller of claim 1, wherein the background operation manager performs the background operation by copying valid data of a victim block among the plurality of memory blocks into a memory of the controller, selects a target block among the plurality of memory blocks, and copies the valid data into the target block such that physical addresses of data having sequential logical addresses in the valid data are sequential.

7. The controller of claim 1, wherein the background operation manager performs the background operation by copying valid data of a victim block among the plurality of memory blocks into a memory of the controller, classifying the valid data into hot data and cold data, and storing the hot data and the cold data in different target blocks among the plurality of memory blocks.

8. The controller of claim 1, wherein the background operation manager performs the background operation by logging an operation history for a longer time period than an existing time period into the memory device.

9. The controller of claim 1, wherein the background operation manager performs the background operation by copying data of a memory block, where the number of read operations performed therein exceeds a threshold value among the plurality of memory blocks, into a memory of the controller and writing the copied data to another memory block.

10. The controller of claim 5, wherein the background operation manager ends the background operation when the remaining memory block usage is completely consumed.

11. An operation method of a controller which controls a memory device including a plurality of memory blocks, the operation method comprising:
monitoring an actual memory block usage of the plurality of memory blocks for a predetermined cycle;
comparing the actual memory block usage to a desired memory block usage indicating the maximum memory block usage for the predetermined cycle; and
performing a background operation according to the memory block usage comparison result.

12. The operation method of claim 11, further comprising:
calculating the maximum memory block usage of the memory device based on the maximum PE cycle count of the plurality of memory blocks and the capacity of the memory device; and
calculating the desired memory block usage based on the maximum memory block usage, a warranty period, and the predetermined cycle.

13. The operation method of claim 11, further comprising calculating a remaining memory block usage for the predetermined cycle, based on the desired memory block usage and the actual memory block usage.

14. The operation method of claim 11, wherein the performing of the background operation comprises:
copying valid data of a victim block among the plurality of memory blocks into a memory of the controller;
selecting a target block among the plurality of memory blocks; and
copying the valid data into the target block such that physical addresses of data having sequential logical addresses in the valid data are sequential.

15. The operation method of claim 11, wherein the performing of the background operation comprises:
copying valid data of a victim block among the plurality of memory blocks into a memory of the controller;
classifying the valid data into hot data and cold data; and
storing the hot data and the cold data in different target blocks among the plurality of memory blocks.

16. The operation method of claim 11, wherein the performing of the background operation comprises logging an operation history for a longer time period than an existing time period into the memory device.

17. The operation method of claim 13, further comprising ending the additional background operation when the remaining memory block usage is completely consumed.

18. A controller for controlling the operation of a memory device, wherein the controller is suitable for:
calculating a desired memory block usage indicating a maximum memory block usage for a predetermined cycle;
comparing the desired memory block usage to an actual memory block usage; and
performing a background operation according to the memory block usage comparison result.

19. The controller of claim 18, wherein the controller is suitable for monitoring memory block usage of a plurality of memory blocks of the memory device for the predetermined cycle, and for storing the actual memory block usage for the predetermined cycle.

20. The controller of claim 19, wherein the controller comprises:
a memory block usage comparator for performing the calculating of the desired memory block usage and the comparing of the desired memory block usage to the actual memory block usage; and
a background operation manager for performing the background operation.
